(19) United States
(12) Patent Application Publication
(10) Pub. No.: US 2001/0049652 A1
(43) Pub. Date: Dec. 6, 2001

(54) Auction system

(76) Inventor: Koichi Nakajima, Nishikamo-gun (JP)

Correspondence Address: STEINBERG & RASKIN, P.C., 1140 AVENUE OF THE AMERICAS, 15th FLOOR, NEW YORK, NY, 10036-5803, US

(21) Appl. No.: 09/870,006

(22) Filed: May 30, 2001

(30) Foreign Application Priority Data
May 31, 2000 (JP) 2000-161461

(51) Int. Cl. G06F 17/60

(52) U.S. Cl. 705/37

(57) ABSTRACT

A challenge faced by the present invention concerns enabling an auction system using a communication network, such as the Internet, to allow a large number of persons to participate in the auction at the same time. In the present invention, which answers this challenge, a management server (M) for managing the auction is connected through the communication network (I) to terminals (C) owned by participants in the auction. The management server (M) includes a bidding management unit (M1) storing a supplied total number of products to be auctioned, and determining whether a demanded total number of products reaches the supplied total number of products or managing the number of bidding sessions, a time period of bidding and so on, and a calculating unit (M2) for calculating a distribution of prices bid by bidders. Thus, the management server calculates the bidding-price distribution at the calculating unit (M2) based on the prices bid by the bidders determined by limiting the supplied total number of products/service. In addition, the bidding management unit (M1) announces the calculated result to the determined bidders through the communication network to urge the determined bidders to bid at the next bidding session with reference to the announced price distribution, and uses the result to decide the bidding price.

### BACKGROUND OF THE INVENTION

1. Field of the Invention

This invention relates to an auction system enabling participants in an auction to purchase products or services (hereinafter collectively referred to as “the product”) at a reasonable market price at all times without bidding speculatively.

2. Description of Related Art

Conventionally known auctions have a system for enabling a bidder who makes a bid of the highest price for a particular product within a designated time to succeed in winning. All the auction participants are in the condition in which nobody knows bidding prices of other participants. Therefore, most of the auction participants typically adopt a strategy of bidding a very low price to observe trends of other participants and then of gradually raising the bidding prices.

In such an auction system, successful bidding prices soar depending on the competition circumstances. Moreover, in many cases, the successful bidding price significantly exceeds a reasonable market price. This brings about the existing condition in which the reliability of the auctions themselves is lost.

With the auction system as explained above, any attempt to perform auctions through the Internet is almost impossible.

For example, in the conventional auction system, the competition for bidding intensifies immediately before the closing of the bidding session, and the bidding tends to become concentrated. However, one of advantages of the auction using the Internet is to permit a large number of participants to participate in the auction at the same time. When the bidding information is concentrated immediately before the closing of the bidding session under the conditions of a large number of people participating in the auction, the amount of bidding information increases enormously, resulting in the possibility of congestion on the Internet.

### SUMMARY OF THE INVENTION

It therefore is an object of the present invention to provide an auction system that enables people to bid successfully at reasonable market prices and does not allow congestion on the Internet.

In a first invention according to the present invention, a management server for managing an auction is connected through a communication network to terminals used by participants in the auction. The management server includes a bidding management unit for storing a supplied total number of products/services supplied to the auction and managing the number of bidding sessions, a time period of bidding and so on, and a calculating unit for calculating a distribution of prices by bidders. The bidding management unit determines bidders at the expiration of an invitation time-period for inviting bids. The calculating unit calculates the distribution of the bidding prices based on the prices bid by the bidders, and the bidding management unit announces the calculated results to the determined bidders through the communication network to urge the determined bidders to bid at the next bidding session with reference to the announced price distribution and to enable them to decide a bidding price based on the calculated results.

In the first invention, as described above, the auction is performed on the precondition that the distribution of the bidding prices is calculated and announced. Accordingly, before the bidding prices are decided, at least one preliminary bidding session should be performed. Participants in the auction decide their final bidding prices based on the price distribution in the preliminary bidding session. Such preliminary bidding session may be repeatedly performed.

According to the auction system of the first invention, since each bidder enters a second-bid with reference to the distribution of the bidding prices resulting from the prior bidding session, each bidder can purchase the product(s) at a price decided personally without being involved in a bidding-price rigging operation. In other words, the bidders are enabled to purchase the product at a reasonable market price.

Accordingly, since the successful bidding price is determined with the reasonable market price as described above, the reliability of auctions is enhanced.

Further, the market price obtained through the prior bidding session is announced at the last step of the prior bidding session. Therefore, the traffic of the bidding information is not concentrated immediately before the closing of the bidding session, resulting in appropriately implementing the auctions of a mass-participant form using the Internet.

Still further, since the bidding participants can refer to the announced market price, the bidding participants are not required to plan a strategy based on price competition and can enter a bid with peace of mind. For the reason of no need of any strategy for the price competition, for example, the bidding is not concentrated immediately before the closing of the auction. Accordingly, even in the auction on the Internet which is predicated on a large number of participants in the auction, the bidding information does not concentrate at a time, resulting in not exceeding system throughput.

As described above, the time period of accepting the bids is delimited and the bidding prices are not processed during this time period. In other words, data manipulation, such as calculating and announcing of the price distribution, is performed by one operation after the expiration of the time period of accepting the bids. With such a configuration, the management server is allowed to process a higher volume of bidding data as compared with the case where the individual positions of the respective bidding prices are determined and announced at all times during the bidding period. In consequence, holding an auction for scores of participants can be accomplished.

In the configuration of a second invention, the bidding management unit stores the supplied total number of products/services supplied to the auction market, and the calculating unit counts the demanded total number of products/services based on the number of participants in the bidding and the number of products demanded by the participants, and the bidding management unit compares the supplied total number of products/services with the demanded total number of products/services and determines the bidders when a relation “the demanded total number>the supplied total number” is established.

A way to cope with when the demanded total number of products/services does not reach the supplied total number of products/services can be decided, as occasion requires. For example, the auction may be called off. Alternatively, participants in the auction may be invited again.

According to the auction system of the second invention, when the relation “the demanded total number>the supplied total number” is established, the bidders are determined. Therefore, each bidder can decide his/her bidding price while considering a possibility of successful bidding. On the other hand, the holder can decide the bid conditions, e.g. the supplied total number of products, while considering a ratio between the demanded total number of products and the supplied total number of products.

In the configuration in a third invention, the bidding management unit stores the invitation time-period and determines the bidders after the expiration of the invitation time-period.

According to the auction system of the third invention, when the invitation time-period has been expired, the bidders are determined. This does not allow the bidding applicants to participate in the bidding during the bidding process after observing the bidding situation. Accordingly, a person without intention of making a successful bid can be removed from the bid participants. By thus removing such a person without intention of making a successful bid, or by performing the auction with only persons who really have a desire for the product, the market price is made that much more reasonable.

In the configuration in a fourth invention, the bidding management unit stores a reserve price or a suggested bidding price and announces it through the communication network.

It should be mentioned that in the first invention, making the announcement of the reserve price is optional. It is not required to announce the reserve price, for example, when there is a possibility that the auction market will be intentionally rigged through the announcement of the reserve price in order to concentrate the bidding price distribution around the reserve price.

According to the auction system of the fourth invention, the reserve price or the suggested bidding price is stored and announced through the communication network. This enables the holder to control the bidding prices to a certain extent. Therefore, the holder is not required to suffer a deficit when holding an auction, resulting in reducing their load of risk. In addition, the holder can open the auction after ensuring the minimum conditions for holding the auction, resulting in reducing the risk of carrying inventories, adjusting returned products, and so on. In this way, the reduction in the load of risk to the holder facilitates an increase in the number of holding the auctions, resulting in invigorating the auction system.

In the configuration of a fifth invention, the calculating unit calculates the price distribution in the first bidding session, calculates the price distributions in the second and later bidding sessions, and compares the calculated results for the second and later bidding sessions with the supplied total number of products/services stored by the bidding management unit to determine the lowest bidding group in reference to the supplied total number of products/services in decreasing order from the highest bidding group in relation to the demanded total number of products/services and sets the bidding price of the lowest bidding group as a market price.

In the fifth invention, as in the first invention, the preliminary bidding session for determining the bidding-price distribution may be performed repeatedly.

According to the auction system of the fifth invention, the price distribution in the first bidding session is calculated, and the price distributions in the second and later bidding sessions are calculated, then the calculated results in the second and later bidding sessions are compared with the supplied total number of products which is stored in the bidding management unit, then the lowest bidding group in reference to the supplied total number of products is determined in decreasing order from the highest bidding group in reference to the demanded total number of products, and then the bidding price of the above lowest bidding group is set as the market price. In consequence, a market price can be determined in the optimum conditions. In other words, through the announcement of the price distribution in the first bidding session, the participants do not need to adopt a strategy for winning the bid. For this reason, a feature of the auction which is price competition can be fully demonstrated.

It should be mentioned that in the first invention, the market price can be defined at any point. Depending upon the situation of the number of applicants, the supplied total number of products or services to be auctioned can be increased or decreased to control the lowest price of the product or service.

### BRIEF DESCRIPTION OF THE DRAWINGS

FIG. 1 is a diagram for a system.

FIG. 2 is a flow chart.

FIG. 3 is a graph showing a decrease in average cost.

FIG. 4 is a graph showing price distribution.

### DETAILED DESCRIPTION OF THE PREFERRED EMBODIMENT

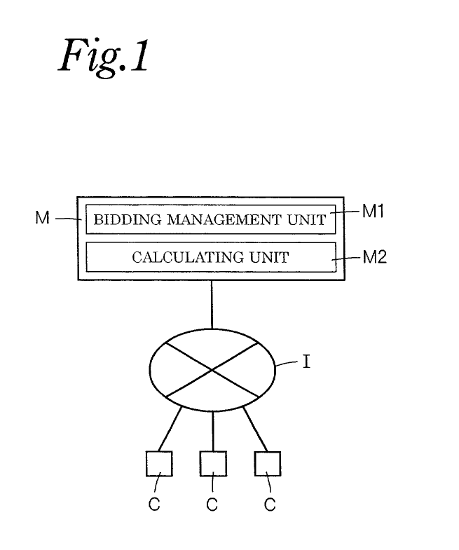

As shown in FIG. 1, terminals C owned by individual participants in an auction are connected to a management server M for managing the auction via a communication network I.

The management server M includes a bidding management unit M1 and a calculating unit M2 which function as follows:

The bidding management unit M1 defines and stores the conditions for each auction session and manages the total number n of products supplied to the auction (hereinafter referred to as “the supplied total number n”), the total number D of demanded products based on the number of bidding applicants and the number of products demanded by the bidding applicants (hereinafter referred to as “the demanded total number D”), the number of bidding sessions m, a time period for bidding T, and so on.

The calculating unit M2 calculates a preliminary price distribution in the first bidding session and also a price distribution in the second bidding session. The calculating unit M2 then compares the calculated results for the second bidding session with the supplied total number n stored in the bidding management unit M1. Then, the calculating unit M2 uses the compared results to determine the lowest bidding group of the successful bidders in relation to the supplied total number n in decreasing order from the highest bidding group in all the bidders in relation to the demanded total number D. A bidding price of the determined lowest bidding group of the successful bidders is defined as a market price.

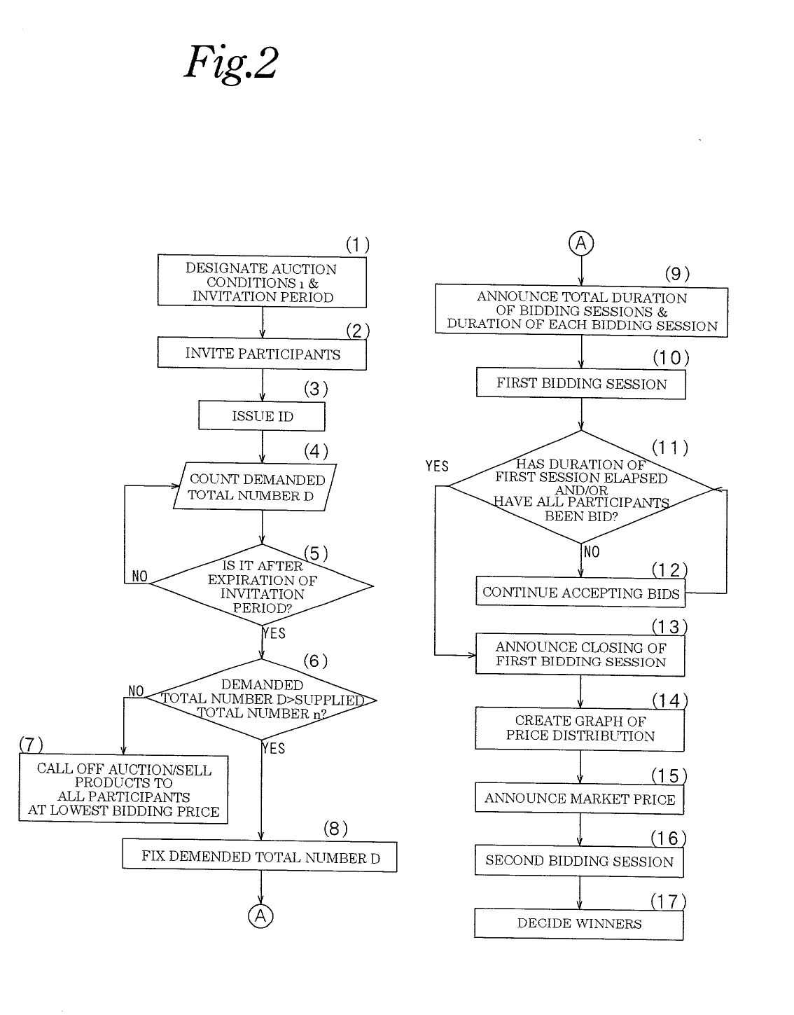

A function of the system according to the embodiment will be described hereinafter with reference to the flow chart illustrated in FIG. 2.

In Step 1, the bidding management unit M1 sets and stores conditions i of the auction and an invitation time-period allowed for inviting participants in the auction.

The conditions i include the supplied total number n, a set reserve price P, a suggested bidding price corresponding to a suggested retail price, an auction process, and so on. After specifying the auction conditions i, a holder of the auction or a supplier of the products makes the conditions i public. “The holder” is used hereinafter as the conception including both the holder of the auction and the supplier of the products.

It should be mentioned that the set reserve price P means the lowest price suggested by the supplier of the products in advance, and not the lowest price resulting from the bidding. Specifically, the supplier supplying the products to an auction market shows a guide in the prices for a certain extent in requiring the auction participants to bid a higher price than a reserve price set by the supplier. This prevents the product at the auction from being sold at an extremely low price so that the supplier suffers a loss.

Instead of the set reserve price P, the suggested bidding price like a so-called suggested retail price may be set in advance. The set reserve price P described herein is the price below which bidders must not bid. On the other hand, the suggested bidding price corresponds to a guideline encouraging bids of a higher price than a suggested price if possible but permitting bids below the suggested price.

However, the holder is at liberty to make his/her own decision as to what constitutes the auction conditions i. For example, the set reserve price P is not necessarily an indispensable factor to be announced. The set reserve price P may not be announced when the holder's announcement of the set reserve price P could raise the possibility that the auction market will be intentionally rigged and the bidding price distribution will be concentrated around the set reserve price P set in advance.

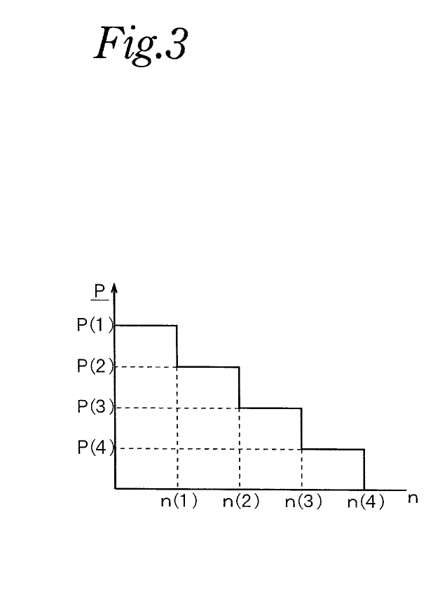

The supplied total number n can be varied in accordance with the demanded total number D based on the number of participants and the number of products demanded by them. Citing one example, the set reserve price P can be varied based on the graph showing the function of average cost illustrated in FIG. 3. The graph of the function of average cost illustrated in FIG. 3 shows the correlation between the number of products n and the price P and represents that the set reserve price P can be decreased as the supplied total number n is increased.

The holder informs applicants for participation in the bidding in advance that the supplied total number n could be increased when the demand total number D is increased, and also makes an announcement that the set reserve price P will be decreased in accordance wit the graph of the function of average cost illustrated in FIG. 3 when the supplied total number n is increased.

Accordingly, the applicants for participation in the bidding will understand that the set reverse price P can be decreased if a lot of other potential applicants are induced to participate in the bidding, resulting in an incentive to ensure the number of participants in the bidding.

In any case, the holder can voluntarily specify the auction conditions i for each auction.

After the auction conditions i are defined and made public at Step 1, the bidding management unit M1 starts inviting participants at Step 2. At Step 3, IDs are issued to the individual applicants to participate. After IDs are thus issued to the applicants, at Step 4 a desired number of products to be purchased by each applicant is registered, and the calculating unit M2 counts the demanded total number D at the time of the registration.

At Step 5, it is determined whether or not the closing time for inviting bids has been reached. If it has not, the processing returns to Step 4 to continue counting the demanded total number D.

Upon the expiration of the invitation time-period, the processing proceeds to Step 6 to determine whether or not the demanded total number D is larger than the supplied total number n (the relation “the demanded total number D>the supplied total number n”) . If the demanded total number D does not exceed the supplied total number n, the processing moves to Step 7, either to call off the auction or to sell the products to all the participants at the lowest bidding price at the time. However, when the demanded total number D does not reach the supplied total number n, the final action depends on the free decision of the holder.

When the condition of the relation “the demanded total number D>the supplied total number n” is satisfied for establishing the auction, the processing proceeds to Step 8 to fix the demanded total number D at this auction. While the demanded total number D is thus fixed, the processing proceeds to Step 9 to notify the participants of the total duration of the bidding sessions and the duration of each bidding session.

The total duration of the bidding sessions and the duration of each bidding session described herein refer to the following: in the embodiment, two bidding sessions are performed. The duration of each bidding session is the duration of performing each of the two bidding sessions and the total duration of the bidding sessions is the total duration for performing both the two bidding sessions.

When the graph showing a decrease in average cost illustrated in FIG. 3 is presented as the auction conditions i, the demanded total numbers D continuously varying during the invitation time-period are announced. The supplied total number n, the set reserve price P, and so on are changed in accordance with the updated demanded total numbers D and then announced at each change.

After all the bid conditions and the like have been ready as explained above, the processing proceeds to Step 10 to carry out the first bidding session. At Step 11, it is determined whether or not the duration of the first bidding session has expired and/or whether or not all the participants have entered their bids. If both the requirements are not met, the processing proceeds to Step 12 to accept further bids. In other words, the acceptance of bids in the first bidding session is closed in either of the following cases: firstly, if all the participants have not entered the first bidding session by the time of the conclusion of the duration of the first bidding session; and, secondly, if all the participants have entered the first bidding session within the duration of the first bidding session. In this point, the acceptance of bids in the first bidding session after all the participants have entered their bids is closed if the condition that each participant is permitted to make one bid during the duration of the first bidding session is specified.

On the other hand, if the requirements at Step 11 are met, the processing proceeds to Step 13 to announce the expiration of the duration of the first bidding session and the non-acceptance of bidding for the first bidding session from this time onward.

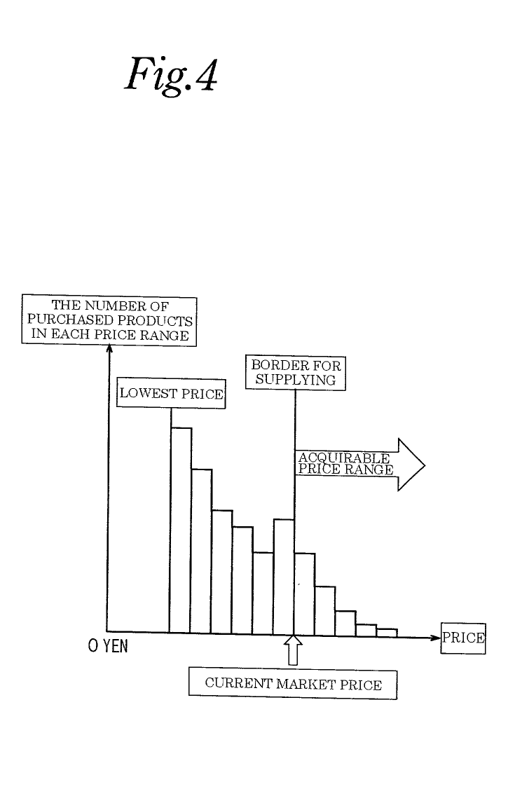

After the first bidding session, the processing proceeds to Step 14 to sort the bidding prices in the first bidding session from the highest bidding price to make the graph of price distribution illustrated in FIG. 4. At this time, the lowest bidding group of the successful bidders is determined in relation to the supplied total number n in decreasing order from the highest bidding group in all the bidders in relation to the demanded total number D which is based on the number of participants in the bidding and the number of products demanded by them. The bidding price of the lowest bidding group is set as a market price resulting from the first bidding session. At Step 15, the market price in the first bidding session is announced to all the participants.

It should be mentioned that the bidding prices in the first bidding session may be announced to all the bid participants. Alternatively, each individual bid participant may be notified of his/her bidding prices and current position in the bidding groups.

After the market price is calculated from the result of the first bidding session and notified to all the bid participants as explained above, a second bidding session is performed at Step 16.

In the second bidding session, each of the participants in the bidding can decide his/her bidding price for the second bidding session with referring to the market price in the first bidding session and his/her position in the bidding groups.

The second bidding session is performed in this way. Then, as in the first bidding session, the lowest bidding group of the successful bidders in relation to the supplied total number n is determined by counting down from the highest bidders of all the bidders in relation to the demanded total number D which is based on the number of bid participants and the number of their demands.

A bidding price of the lowest bidding group of the successful bidders is defined as the successfully bidding price in the auction and announced to the successful bidders (Step 17).

The auction system of the aforementioned embodiment is described on the assumption that a single participant buys a plurality of the products. Accordingly, the aforementioned demanded total number D is determined by “the summation of the numbers of products demanded by the individual bid participants”. The reason why the number of bid participants is not equal to the demanded total number is, for example, based on the assumption that a limited quantity of admission thickets are put up for auction.

One specific example is that, in the event of the purchase of admission tickets to a live concert of a certain singer, a person may purchase a plurality of the tickets for himself/herself and friends. In this case, a general view is that the combination of the representative person and his/her friends enters a single bid at the same price. Assuming such a case, the number of products demanded by a participant is not necessarily one.

Hence, the aforementioned demanded total number D is determined by “the summation of the numbers of products demanded by the individual bid participants”. However, depending upon a product to be auctioned, the number of bidding participants could be equal to the demanded total number D. In this case, it is a foregone conclusion that the setting of the relation “the demanded total number D=the number of bidding participants” is justified.

When the demanded total number D is set as “the summation of the numbers of products demanded by the individual bid participants” as described above, it may be possible to imagine that the demanded total number D of products demanded by the bidders from the highest bidding group to the lowest successful bidding group exceeds the supplied number n. In this case, a process in which the bidders of the lowest successful bidding group draw lots to decide the winner could be possible. In any case, the ranking of the successful bidders should be decided by the holder. One example is a practice of giving a high priority to a bidder purchasing a lot of products.

As a precondition in the embodiment, one bidder makes a single bid during each time period of accepting bids. There is no problem if replacement of the bidding price during the time period of accepting bids is acknowledged. The reason is that even if a participant replaces his/her bidding prices many times during the time period of accepting bids, the processing requires only one bidding price per participant in the above time period.

However, in order to reduce load of processes in servers or on the Internet, it is preferable to establish limitation of the number of replacing the bidding prices.

In the system of the above embodiment, the number of bidding sessions is set at two times, but there may be more or less than two sessions. However, there is not much point in increasing the number of bidding sessions. The reason is that the system of the embodiment has a feature in that the first bidding session serves as a preliminary bidding for determining the aforementioned market price, and therefore an increase in the number of bidding sessions only means to increase the number of preliminary bidding sessions.

However, depending upon the products to be auctioned or the bidding situation, the bidding prices can be appropriately distributed by increasing the number of bidding sessions. In this case, the market price may be determined every time the number of bidding sessions is increased.

In the auction system as described above, successful bidding prices do not soar depending on the competition circumstances. The reason is that the announcement of the market price after the closing of the first bidding session enables the participants to participate in the second and later bidding sessions with reference to the announced market price. In other words, in the second and later bidding sessions, all the participants in the bidding can determine their reasonable bidding prices with reference to the market price and their individual bidding groups.

Moreover, each of the participants can participate in the second and later bidding sessions at a reasonable price decided personally while roughly seeing the bidding situation through the first bidding session. For this reason, the traffic of the bid information is not concentrated immediately before the closing of accepting bids. In consequence, the aforementioned auction system best suits use in an auction of a mass participant form using the Internet.

### EXPLANATION OF CODES

C TERMINAL

M MANAGEMENT SERVER

M1 BIDDING MANAGEMENT UNIT

M2 CALCULATING UNIT

I COMMUNICATION NETWORK

What is claimed is:

1. An auction system comprising:
a management server for managing an auction connected through a communication network to terminals used by participants in the auction, and including a bidding management unit for storing a supplied total number of products or services supplied for the auction and managing the number of bidding sessions, and a time period of bidding, and a calculating unit for calculating a distribution of prices by bidders, wherein said bidding management unit determines bidders at the expiration of an invitation time-period for inviting bids, and said calculating unit calculates the distribution of the bidding prices based on the prices bid by the bidders, and said bidding management unit announces the calculated results to the determined bidders through the communication network to urge the determined bidders to bid at the next bidding session with reference to the announced price distribution and to enable them to decide a bidding price based on the calculated results.

2. The auction system according to claim 1, wherein said bidding management unit stores said supplied total number of products or services supplied to the auction market, and said calculating unit counts a demanded total number of products or services based on the number of participants in the bidding and the number of products demanded by the participants, and the bidding management unit compares said supplied total number of products with said demanded total number of products and determines the bidders when a relation “the demanded total number>the supplied total number” is established.

3. The auction system according to claim 1 or 2, wherein said bidding management unit stores the invitation time-period and determines the bidders after the expiration of the invitation time-period.

4. The auction system according to any one of claims 1, 2 and 3, wherein said bidding management unit stores a reserve price or a suggested bidding price and announces it through the communication network.

5. The auction system according to any one of claims 1, 2, 3 and 4, wherein said calculating unit calculates the price distribution in the first bidding session, calculates the price distributions in the second and later bidding sessions, and compares the calculated results for the second and later bidding sessions with the supplied total number of products or services stored by said bidding management unit to determine the lowest bidding group in reference to the supplied total number of products or services in decreasing order from the highest bidding group in relation to the demanded total number of products or services and sets the bidding price of said lowest bidding group as a market price.
